(19) United States
(12) Patent Application Publication
(10) Pub. No.: US 2026/0273864 A1
(43) Pub. Date: Sep. 17, 2026

(54) METHOD FOR MANUFACTURING THREE-DIMENSIONAL SHAPED OBJECT

(71) Applicant: SEIKO EPSON CORPORATION, Tokyo (JP)

(72) Inventor: Keigo ISHIKURA, SHIOJIRI-SHI (JP)

(21) Appl. No.: 19/563,508

(22) Filed: Mar. 11, 2026

(30) Foreign Application Priority Data
Mar. 14, 2025 (JP) 2025-041043

(51) Int. Cl. B29C 64/393; B33Y 10/00; B33Y 40/10; B33Y 50/02

(52) U.S. Cl. CPC B29C 64/393; B33Y 10/00; B33Y 40/10; B33Y 50/02

(57) ABSTRACT

In a method for manufacturing a three-dimensional shaped object, a second shaped object, which is a duplicate of a first shaped object, is shaped on a stage by ejecting a shaping material from an ejecting unit toward the stage. The method for manufacturing the three-dimensional shaped object includes a path data acquisition step of acquiring first path data for shaping the first shaped object, a path data duplication step of generating second path data for shaping the second shaped object based on the first path data and a position at which the second shaped object is to be shaped on the stage, and a shaping step of shaping the second shaped object based on the second path data.

### CROSS REFERENCE TO RELATED APPLICATION

The present application is based on, and claims priority from JP Application Serial Number 2025-041043, filed Mar. 14, 2025, the disclosure of which is hereby incorporated by reference herein in its entirety.

### BACKGROUND

### 1. Technical Field

The present disclosure relates to a method for manufacturing a three-dimensional shaped object.

### 2. Related Art

In the related art, a three-dimensional shaping device as disclosed in JP-A-2012-101446 is known. In such a device, a plurality of shaped objects having the same shape can be simultaneously produced.

JP-A-2012-101446 is an example of the related art.

However, in thermofusible three-dimensional shaping as disclosed in JP-A-2012-101446, when a plurality of shaped objects having the same shape are produced, if positions and angles of the shaped objects are different, shaping paths are not the same, and the shaping quality of each shaped object may deviate.

### SUMMARY

A method for manufacturing a three-dimensional shaped object for shaping a second shaped object, which is a duplicate of a first shaped object, on a stage by ejecting a shaping material from an ejecting unit toward the stage, the method includes: an acquisition step of acquiring first path data for shaping the first shaped object; a duplication step of generating second path data for shaping the second shaped object, based on the first path data and a position at which the second shaped object is to be shaped on the stage; and a shaping step of shaping the second shaped object based on the second path data.

### BRIEF DESCRIPTION OF THE DRAWINGS

FIG. 1 is a diagram showing a schematic configuration of a three-dimensional shaping system.

FIG. 2 is a diagram showing a schematic configuration of a material supply unit and a head.

FIG. 3 is a perspective view showing a schematic configuration of a flat screw.

FIG. 4 is a schematic plan view of a barrel.

FIG. 5 is a diagram schematically illustrating a state where a three-dimensional shaping device shapes a shaped object.

FIG. 6 is a flowchart of shaping processing executed in the three-dimensional shaping system.

FIG. 7 is a diagram showing the shaping processing according to an embodiment.

FIG. 8 is a diagram showing shaping processing according to Modification 1.

FIG. 9 is a diagram showing shaping processing according to Modification 2.

FIG. 10 is a diagram showing shaping processing according to Modification 3.

FIG. 11 is a diagram showing shaping processing according to Modification 4.

### DESCRIPTION OF EMBODIMENTS

### 1. Embodiment

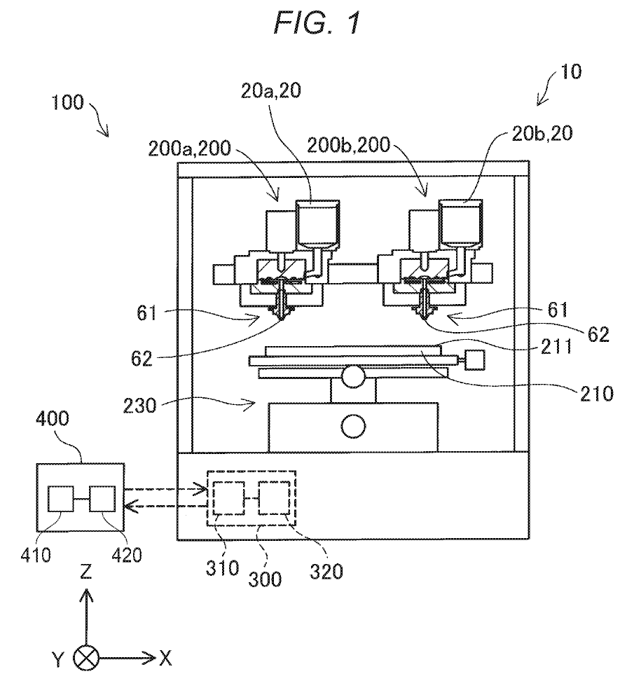

FIG. 1 is a diagram showing a schematic configuration of a three-dimensional shaping system 10 according to an embodiment. FIG. 1 shows arrows indicating X, Y, and Z directions perpendicular to one another. The X direction and the Y direction are directions parallel to a horizontal plane, and the Z direction is a direction along a vertically upward direction. The arrows indicating the X, Y, and Z directions are shown as appropriate in other drawings as well in such a way that the shown directions correspond to those in FIG. 1. In the description below, to specify an orientation, a direction indicated by an arrow in the drawings is defined as "+" and a direction opposite to that direction is defined as "-", and the positive and negative signs are also used in the representation of directions. Hereinafter, a +Z direction is also referred to as "up", and a -Z direction is also referred to as "down". A plane along the X direction and the Y direction is also referred to as an "XY plane". A direction along the XY plane is also referred to as an XY direction.

The three-dimensional shaping system 10 includes a three-dimensional shaping device 100 and an information processing device 400. The three-dimensional shaping device 100 according to the embodiment is a device that shapes a three-dimensional shaped object by a material extrusion method. The three-dimensional shaping device 100 includes a control unit 300 for controlling each part of the three-dimensional shaping device 100. The control unit 300 and the information processing device 400 are communicably connected to each other.

The three-dimensional shaping device 100 includes a first head 200a, a second head 200b, a first material supply unit 20a, a second material supply unit 20b, a stage 210, and a movement mechanism 230 in addition to the control unit 300. Hereinafter, when the first head 200a and the second head 200b are not particularly distinguished from each other, they may be simply referred to as a head 200. Similarly, when the first material supply unit 20a and the second material supply unit 20b are not particularly distinguished from each other, they may be simply referred to as a material supply unit 20.

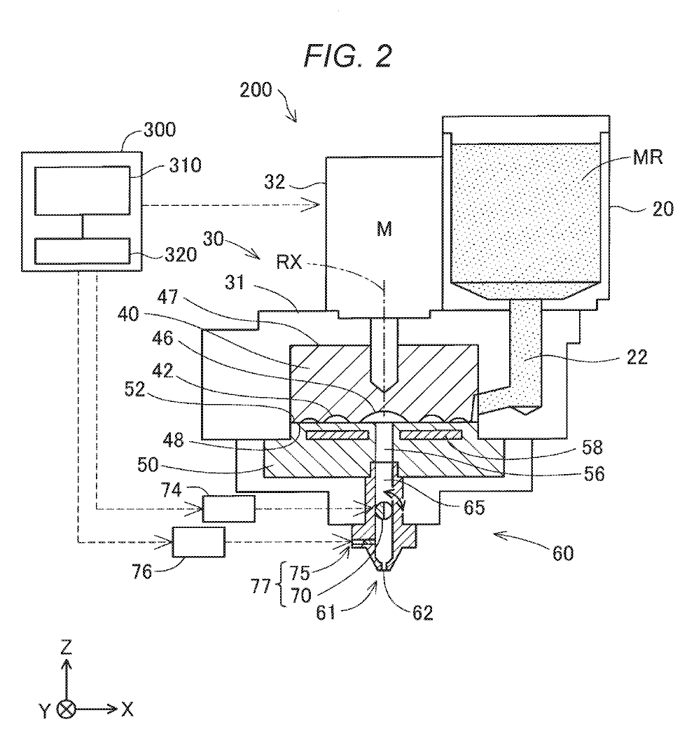

FIG. 2 is a diagram showing a schematic configuration of the material supply unit 20 and the head 200. The head 200 includes a plasticizing unit 30 and an ejecting unit 60 having a nozzle 61. A material accommodated in the material supply unit 20 is supplied to the head 200. Under the control of the control unit 300, the head 200 plasticizes at least a part of the material supplied from the material supply unit 20 by the plasticizing unit 30 to generate a shaping material, and ejects the generated shaping material from the nozzle 61 onto the stage 210 for stacking. In the embodiment, the term "plasticize" refers to a concept including melting and refers to changing a solid state to a fluid state. Specifically, in the case of a material in which glass transition occurs, plasticizing means setting a temperature of the material to be equal to or higher than a glass transition point. When the glass transition does not occur in the material, plasticizing means setting the temperature of the material to be equal to or higher than a melting point.

The material supply unit 20 is implemented by, for example, a hopper that accommodates a material. The material supply unit 20 is coupled to the plasticizing unit 30 via a communication path 22. The material is put into the material supply unit 20 in a form of pellets, powder, or the like. In the embodiment, a pellet-shaped ABS resin material is used. In the embodiment, a first material is accommodated in the first material supply unit 20a, and a second material is accommodated in the second material supply unit 20b. Therefore, the first material accommodated in the first material supply unit 20a is supplied to the first head 200a, and the second material accommodated in the second material supply unit 20b is supplied to the second head 200b. Hereinafter, the first material and the second material are also referred to as a raw material MR without distinction.

The plasticizing unit 30 includes a screw case 31, a drive motor 32, a flat screw 40, and a barrel 50. The flat screw 40 is also referred to as a rotor or a scroll. The barrel 50 is also referred to as a screw-facing part.

The flat screw 40 is accommodated in the screw case 31. An upper surface 47 of the flat screw 40 is coupled to the drive motor 32, and the flat screw 40 rotates in the screw case 31 by a rotational drive force generated by the drive motor 32. The drive motor 32 is driven under the control of the control unit 300. The flat screw 40 may be driven by the drive motor 32 via a decelerator.

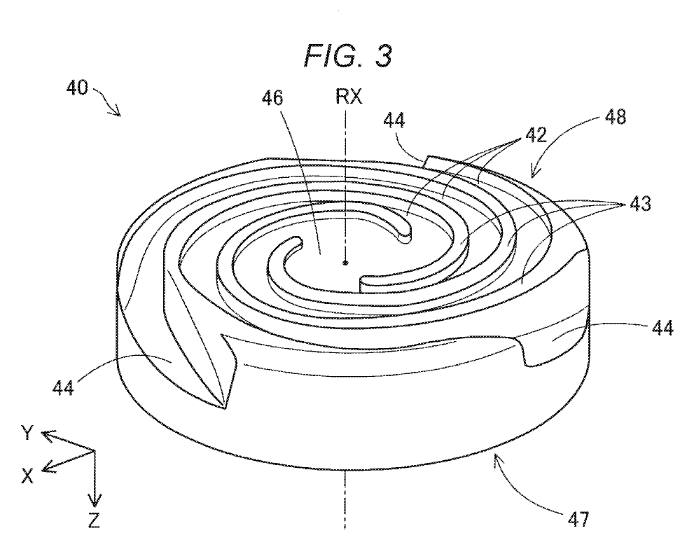

FIG. 3 is a perspective view showing a schematic configuration of a lower surface 48 side of the flat screw 40. In order to facilitate understanding of the technique, the flat screw 40 shown in FIG. 3 is shown in a state where a positional relationship between the upper surface 47 and the lower surface 48 shown in FIG. 2 is reversed in a vertical direction. The flat screw 40 has a substantially cylindrical shape whose length in an axial direction that is a direction along a central axis thereof is shorter than a length in a direction perpendicular to the axial direction. The flat screw 40 is disposed in such a way that a rotation axis RX that is a rotation center thereof is parallel to the Z direction.

Grooves 42 each having a vortex shape are formed in the lower surface 48, which is a surface crossing the rotation axis RX, of the flat screw 40. The communication path 22 of the material supply unit 20 communicates with the grooves 42 from a side surface of the flat screw 40. In the embodiment, three grooves 42 are formed, separated from each other by protruding parts 43. The number of grooves 42 is not limited to three and may be one or may be two or more. The grooves 42 are not limited to the vortex shape and may have a spiral shape or an involute curve shape, or may have a shape extending arcuately from a central part toward the outer circumference.

As shown in FIG. 2, the lower surface 48 of the flat screw 40 faces an upper surface 52 of the barrel 50. A space is formed between the grooves 42 in the lower surface 48 of the flat screw 40 and the upper surface 52 of the barrel 50. The raw material MR is supplied from the material supply unit 20 to the space between the flat screw 40 and the barrel 50 through material inlets 44 shown in FIG. 3.

A barrel heater 58 for heating the raw material MR supplied into the grooves 42 of the rotating flat screw 40 is embedded in the barrel 50. A communication hole 56 is provided at the center of the barrel 50.

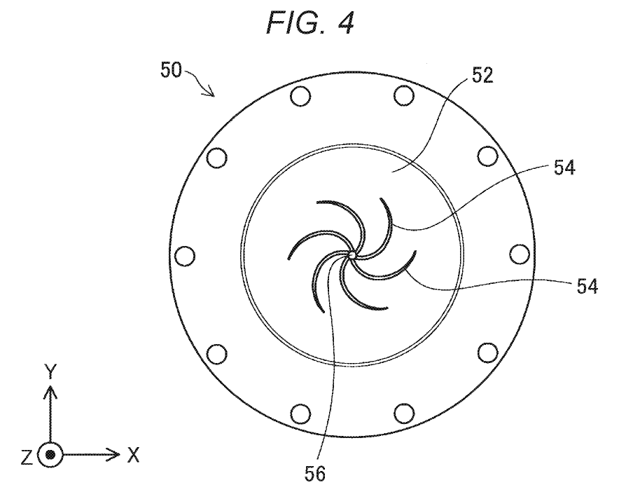

FIG. 4 is a schematic plan view showing the upper surface 52 side of the barrel 50. A plurality of guide grooves 54 coupled to the communication hole 56 and extending in a vortex shape from the communication hole 56 toward the outer circumference are formed in the upper surface 52 of the barrel 50. One end of the guide groove 54 may not be coupled to the communication hole 56. The guide groove 54 may be omitted.

The raw material MR supplied into the grooves 42 of the flat screw 40 flows along the grooves 42 due to the rotation of the flat screw 40 while being plasticized in the grooves 42, and is guided to a central part 46 of the flat screw 40 as the shaping material. The paste-like shaping material exhibiting fluidity, which flows into the central part 46, is supplied to the ejecting unit 60 via the communication hole 56 provided at the center of the barrel 50. In the shaping material, not all the kinds of substances forming the shaping material may be plasticized. The shaping material may be converted into a fluid state as a whole by plasticizing at least a part of the kinds of substances forming the shaping material.

As shown in FIG. 2, the ejecting unit 60 includes the nozzle 61 that ejects the shaping material, a flow path 65 for the shaping material that is formed between the flat screw 40 and a nozzle opening 62, and an ejection control unit 77 that controls the ejection of the shaping material.

The nozzle 61 is coupled to the communication hole 56 of the barrel 50 through the flow path 65. The nozzle 61 ejects the shaping material generated by the plasticizing unit 30, from the nozzle opening 62 at a tip end toward the stage 210.

The ejection control unit 77 includes an ejection adjustment unit 70 that opens and closes the flow path 65 and a suction unit 75 that suctions and temporarily stores the shaping material.

The ejection adjustment unit 70 is provided in the flow path 65 and changes an opening degree of the flow path 65 by rotating in the flow path 65. In the embodiment, the ejection adjustment unit 70 is implemented by a butterfly valve. The ejection adjustment unit 70 is driven by a first drive unit 74 under the control of the control unit 300. The first drive unit 74 is implemented by, for example, a stepping motor. The control unit 300 can adjust a flow rate of the shaping material flowing from the plasticizing unit 30 to the nozzle 61, that is, an ejecting amount of the shaping material ejected from the nozzle 61 by controlling a rotation angle of the butterfly valve using the first drive unit 74. The ejection adjustment unit 70 can adjust the ejecting amount of the shaping material and can control the ON and OFF of the outflow of the shaping material.

The suction unit 75 is coupled at a site between the ejection adjustment unit 70 and the nozzle opening 62 in the flow path 65. The suction unit 75 temporarily suctions the shaping material in the flow path 65 when the ejection of the shaping material from the nozzle 61 is stopped, and thereby prevents a trailing phenomenon in which the shaping material hangs down like a string from the nozzle opening 62. In the embodiment, the suction unit 75 is implemented by a plunger. The suction unit 75 is driven by a second drive unit 76 under the control of the control unit 300. The second drive unit 76 is implemented by, for example, a stepping motor and a rack-and-pinion mechanism that converts a rotational force generated by the stepping motor into a translational motion of the plunger.

As shown in FIG. 1, the stage 210 is disposed at a position facing the nozzle opening 62 of the nozzle 61. In the embodiment, a shaping surface 211 of the stage 210 facing the nozzle opening 62 of the nozzle 61 is disposed in parallel to the XY direction, that is, a horizontal direction. The stage 210 may include a stage heater for preventing rapid cooling of the shaping material ejected onto the stage 210.

The movement mechanism 230 changes a relative position between the stage 210 and the nozzle 61 under the control of the control unit 300. In the embodiment, the position of the nozzle 61 is fixed, and the movement mechanism 230 moves the stage 210. The movement mechanism 230 is implemented by a three-axis positioner that moves the stage 210 in three axial directions, that is, the X, Y, and Z directions, by drive forces of three motors. In the present specification, the movement of the nozzle 61 means moving the nozzle 61 or the ejecting unit 60 relatively to the stage 210, unless stated otherwise.

In another embodiment, a configuration in which the movement mechanism 230 moves the nozzle 61 with respect to the stage 210 in a state where the position of the stage 210 is fixed may be employed instead of the configuration in which the movement mechanism 230 moves the stage 210. A configuration in which the movement mechanism 230 moves the stage 210 in the Z direction and moves the nozzle 61 in the XY direction, or a configuration in which the movement mechanism 230 moves the stage 210 in the XY direction and moves the nozzle 61 in the Z direction may be employed. With these configurations, a relative positional relationship between the nozzle 61 and the stage 210 can be changed.

The control unit 300 is a control device that controls operations of the entire three-dimensional shaping device 100. The control unit 300 is implemented by a computer including one or a plurality of processors 310, a storage device 320 made up of a main storage device and an auxiliary storage device, and an input and output interface for inputting and outputting a signal from and to outside. The processor 310 executes a program stored in the storage device 320, thereby controlling the head 200 and the movement mechanism 230 according to shaping data acquired from the information processing device 400 to shape a shaped object on the stage 210. The control unit 300 may be implemented by combining circuits together, instead of being implemented by a computer.

The information processing device 400 outputs, to the control unit 300, the shaping data used when the three-dimensional shaping device 100 shapes the shaped object. The shaping data includes path data and ejecting amount information. The path data is data in which a movement path, which is a path along which the nozzle 61 moves while ejecting the shaping material, is represented by a plurality of partial paths. The partial path is a linear path, and is represented using, for example, a start point and an end point of the partial path. The ejecting amount information is information representing an ejecting amount of the shaping material in each partial path.

The information processing device 400 is implemented by a computer including one or a plurality of processors 410, a storage device 420 made up of a main storage device and an auxiliary storage device, and an input and output interface for inputting and outputting a signal from and to outside. The storage device 420 according to the embodiment stores a data generation program for generating the shaping data. The processor 410 can generate the shaping data by executing the data generation program.

The information processing device 400 outputs the generated shaping data to the control unit 300. The information processing device 400 can generate shaping data for shaping a plurality of shaped objects side by side by duplicating the path data in the process of generating the shaping data. Generation of the shaping data will be described later. Since the shaping data includes the path data, performing shaping based on the shaping data can be rephrased as performing shaping based on the path data.

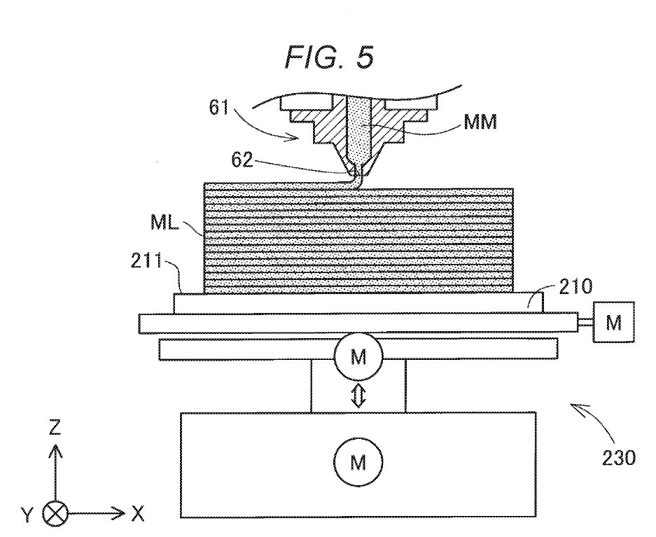

FIG. 5 is a diagram schematically showing a state where the three-dimensional shaping device 100 shapes a shaped object. As described above, in the three-dimensional shaping device 100, the solid-state raw material MR is plasticized to generate a shaping material MM. The control unit 300 causes the nozzle 61 to eject the shaping material MM while changing the position of the nozzle 61 relative to the stage 210 in a direction along the shaping surface 211 of the stage 210 and maintaining a distance between the shaping surface 211 of the stage 210 and the nozzle 61. The shaping material MM ejected from the nozzle 61 is continuously deposited in a movement direction of the nozzle 61.

The control unit 300 repeats the movement of the nozzle 61 and thus forms layers ML. After forming one layer ML, the control unit 300 moves the position of the nozzle 61 relative to the stage 210 in the Z direction which is a stacking direction. Then, the control unit 300 shapes a shaped object by further stacking the layer ML on the layer ML that has been formed to that point. In the process of shaping the shaped object, the path along which the nozzle 61 moves relative to the stage 210 is defined by the path data included in the shaping data. In the process of shaping the shaped object, an amount of the shaping material MM ejected from the nozzle 61 is defined by the ejecting amount information included in the shaping data.

For example, when the nozzle 61 is moved in the Z direction after completion of one layer ML or when there are a plurality of independent shaping regions in each layer, the control unit 300 may temporarily interrupt the ejection of the shaping material MM from the nozzle 61. In this case, the flow path 65 is closed by the ejection adjustment unit 70, the ejection of the shaping material MM from the nozzle opening 62 is stopped, and the shaping material MM in the nozzle 61 is temporarily suctioned by the suction unit 75. After changing the position of the nozzle 61, the control unit 300 discharges the shaping material MM from inside the suction unit 75 and opens the flow path 65 by the ejection adjustment unit 70, and thus resumes the deposition of the shaping material MM from the changed position of the nozzle 61.

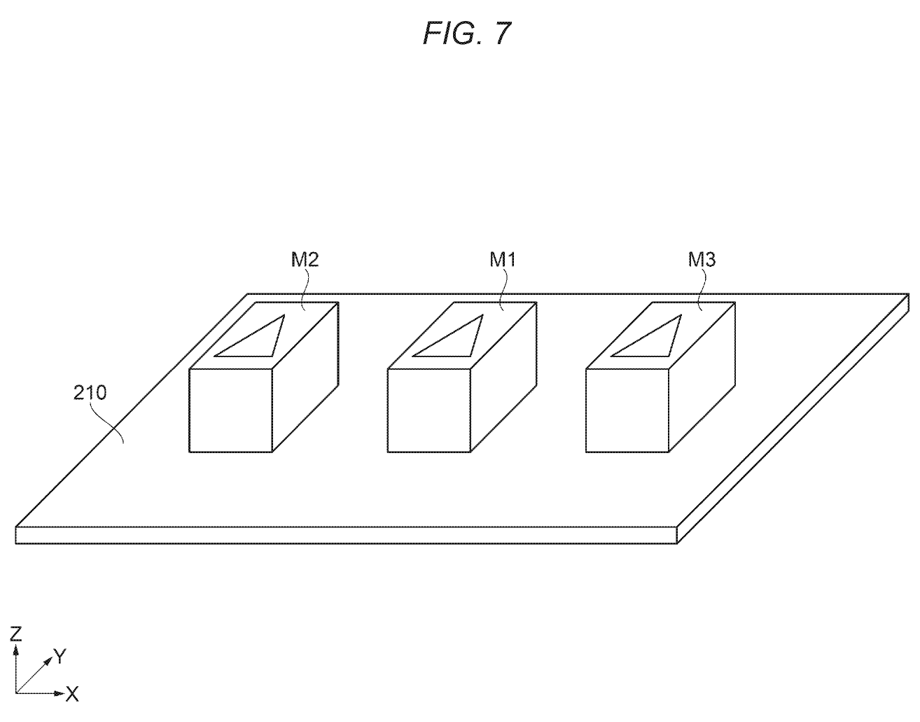

Next, shaping processing of the embodiment will be described. As described above, the shaping processing of the embodiment includes processing of shaping the plurality of shaped objects side by side on the stage 210 by duplicating the path data used when shaping one shaped object. Hereinafter, as an example, as shown in FIG. 7, the processing of shaping three shaped objects including a first shaped object M1, a second shaped object M2, and a third shaped object M3 side by side on the stage 210 will be described. The first shaped object M1, the second shaped object M2, and the third shaped object M3 are shaped at different positions in the XY direction on the stage 210. However, the positions, orientations, and sizes of the three shaped objects in the Z direction are the same. The first shaped object M1 is shaped based on first path data that is path data of a duplication source, and the second shaped object M2 and the third shaped object M3 are shaped based on second path data and third path data that are duplicated path data.

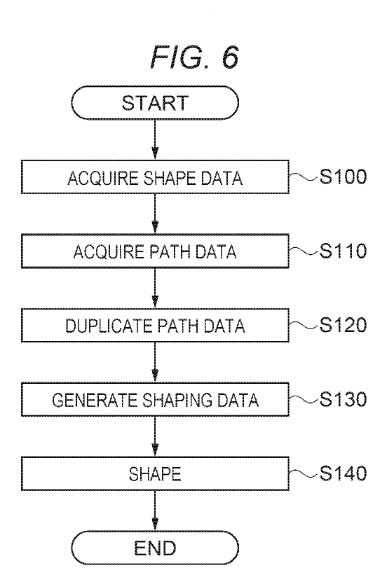

FIG. 6 is a flowchart of shaping processing executed in the three-dimensional shaping system 10 according to the embodiment. The shaping processing is processing for implementing a method for manufacturing a three-dimensional shaped object. The shaping processing is executed, for example, when a predetermined start operation is performed by a user on the information processing device 400. When the start operation is performed by the user, the information processing device 400 executes the following operation by the processor 410 executing the data generation program.

In a shape data acquisition step of step S100, the information processing device 400 acquires shape data representing the shape of the first shaped object M1 from another computer, a recording medium, or the storage device 420. The information processing device 400 acquires, as the shape data, three-dimensional shape data generated using three-dimensional CAD software, three-dimensional CG software, or the like. In this case, the shape data is, for example, data in an STL format or an AMF format. In the embodiment, the entire shaped object is shaped with at least one of the first material and the second material. The shape data may be data representing the shape of the shaped object, and may be, for example, shaping data generated by another three-dimensional shaping device or another computer. In this case, the information processing device 400 may obtain the shape data of the first shaped object M1 by analyzing the shaping data.

In a path data acquisition step of step S110, the information processing device 400 acquires path data based on the acquired shape data. Specifically, the information processing device 400 virtually slices the first shaped object M1 represented by the shape data into a plurality of layers along the XY plane, and generates slice data for shaping the first shaped object M1 for each layer. The slice data includes the path data for shaping the first shaped object M1 and ejecting amount information associated with the path data. The path data included in the slice data generated in step S110 corresponds to the first path data. Step S110 of generating the slice data including the first path data corresponds to an acquisition step of acquiring the first path data.

In a path data duplication step of step S120, the information processing device 400 generates the second path data for shaping the second shaped object M2, based on the first path data and the position in the XY direction at which the second shaped object M2 is to be shaped on the stage 210. The position in the XY direction at which the second shaped object M2 is to be shaped is a position different from the position of the first shaped object M1, and can be freely designated by the user. The shape of the path represented by the second path data is the same as the shape of the path represented by the first path data. When one path is parallelly moved, rotated, or enlarged or reduced to match the other path, it is expressed that both paths have the same shape. Further, the path represented by the second path data does not intersect the path represented by the first path data. Hereinafter, generation of path data having the same path is referred to as duplication. That is, in step S120, the information processing device 400 generates the second path data by duplicating the first path data and then changing the position of the path in the XY direction in the first path data.

In the path data duplication step of step S120, the information processing device 400 generates the third path data for shaping the third shaped object M3, based on the first path data and the position in the XY direction at which the third shaped object M3 is to be shaped on the stage 210. The position in the XY direction at which the third shaped object M3 is to be shaped is a position different from the positions of the first shaped object M1 and the second shaped object M2, and can be freely designated by the user. The shape of the path represented by the third path data is the same as the shape of the path represented by the first path data. Further, the path represented by the third path data does not intersect the path represented by the first path data and the path represented by the second path data. In step S120, the information processing device 400 generates the third path data by duplicating the first path data and then changing the position of the path in the XY direction in the first path data.

In a shaping data generation step of step S130, the information processing device 400 generates the shaping data based on the first path data generated in step S110, the second path data and the third path data generated in step S120, and the ejecting amount information generated in step S110. The shaping data generated here is shaping data for shaping the three shaped objects including the first shaped object M1, the second shaped object M2, and the third shaped object M3 for each layer ML.

In a shaping step of step S140, the control unit 300 shapes, based on the shaping data generated by the information processing device 400, the first shaped object M1, the second shaped object M2, and the third shaped object M3 by stacking the shaping material MM on the stage 210 while moving the nozzle 61. The shaping of the shaped object based on the shaping data generated based on the first path data, the second path data, and the third path data includes shaping the first shaped object M1 based on the first path data, shaping the second shaped object M2 based on the second path data, and shaping the third shaped object M3 based on the third path data.

Here, the second shaped object M2 and the third shaped object M3 are shaped based on the second path data and the third path data generated by duplicating the first path data for shaping the first shaped object M1, and thus can be regarded as a duplicate of the first shaped object M1. That is, in the method for manufacturing the three-dimensional shaped object according to the embodiment, the first shaped object M1, and the second shaped object M2 and the third shaped object M3, which are duplicates of the first shaped object M1, are shaped side by side on the stage 210 by ejecting the shaping material MM from the ejecting unit 60 toward the stage 210.

According to the method for manufacturing the three-dimensional shaped object of the embodiment described above, the shape of the path represented by the second path data and the third path data is the same as the shape of the path represented by the first path data. In other words, the second shaped object M2 and the third shaped object M3 are shaped along a path having the same shape as the first shaped object M1. That is, it is possible to shape a plurality of shaped objects having the same external shape and the same internal path. Accordingly, when the plurality of shaped objects having the same shape are produced, it is possible to prevent quality deviation due to a difference in position or angle.

### 2. Modifications

### 2-1. Modification 1

In the above embodiment, an aspect in which the plurality of shaped objects are shaped at different positions in the XY direction and at the same position in the Z direction has been described, but the plurality of shaped objects may be shaped at different positions in the Z direction as long as the shapes of the paths are the same. That is, in the path data duplication step of step S120, the position in the Z direction of the path represented by the second path data and the third path data may be changeable from the position in the Z direction of the path represented by the first path data. In this case, the positions of the plurality of shaped objects in the XY direction may be the same or different. The position in the Z direction at which each shaped object is to be shaped is designated by, for example, the user.

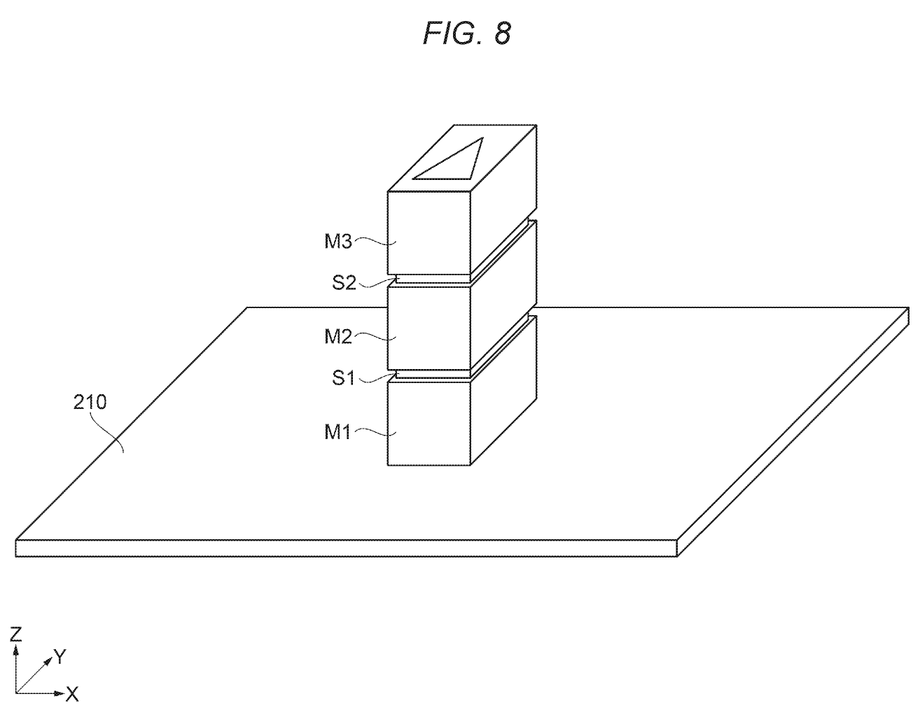

FIG. 8 is a diagram showing an example in which three shaped objects are shaped at different positions in the Z direction. In this example, the first shaped object M1 is shaped on the stage 210, the second shaped object M2 is shaped in the +Z direction of the first shaped object M1, and the third shaped object M3 is shaped in the +Z direction of the second shaped object M2. In this case, in the path data duplication step of step S120, the information processing device 400 generates the second path data by duplicating the first path data and then changing the position of the path in the Z direction to a value larger than the position in the Z direction in the first path data. Similarly, the information processing device 400 generates the third path data by duplicating the first path data and then changing the position of the path in the Z direction to a value larger than the position in the Z direction in the second path data. The information processing device 400 adds path data for support shaping to the shaping data such that supports S1 and S2 are shaped between the first shaped object M1 and the second shaped object M2 and between the second shaped object M2 and the third shaped object M3. The supports S1 and S2 may have any shape as long as they can support the duplicated shaped object disposed in the +Z direction, and the shape of the path is not limited.

According to a method for manufacturing a three-dimensional shaped object in Modification 1, in the path data duplication step of step S120, the position in the Z direction of the path represented by the second path data, that is, the position in a direction intersecting the stage 210 can be changed from the position in the Z direction of the path represented by the first path data. Therefore, the second shaped object M2 can be disposed on the +Z direction side of the first shaped object M1. Accordingly, compared to a case where a duplicated shaped object is disposed only on the shaping surface 211 on the stage 210, since the duplicated shaped object can be disposed in the space on the stage 210, more shaped objects can be shaped at once.

### 2-2. Modification 2

In the above embodiment, an aspect in which the plurality of shaped objects are shaped in the same orientation has been described, but the plurality of shaped objects may be shaped in different orientations as long as the shapes of the paths are the same. That is, in the path data duplication step of step S120, the orientations of the paths represented by the second path data and the third path data may be changeable from the orientation of the path represented by the first path data. The orientation of each shaped object is designated by, for example, the user.

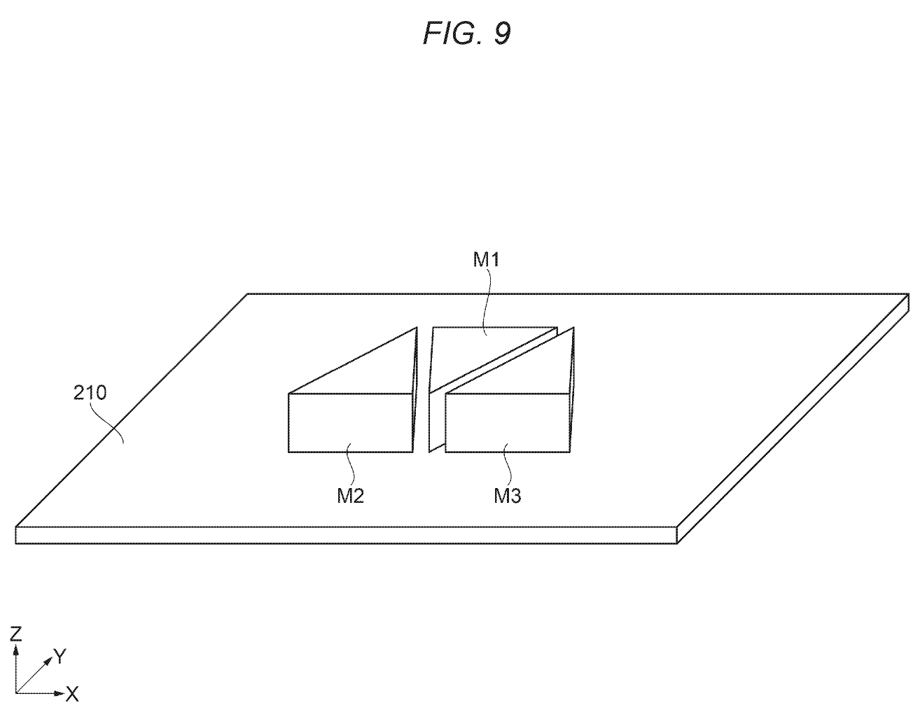

FIG. 9 is a diagram showing an example in which three shaped objects are shaped in different orientations. In FIG. 9, the first shaped object M1, the second shaped object M2, and the third shaped object M3 have different orientations in a direction intersecting the Z axis. That is, each shaped object can be disposed on the stage 210 in an orientation designated by the user. In FIG. 9, the three shaped objects have a triangular prism shape, and the orientations of the second shaped object M2 and the third shaped object M3 disposed on the both sides of the first shaped object M1 are different from the orientation of the first shaped object M1 by 180°. In this case, in the path data duplication step of step S120, the information processing device 400 generates the second path data by duplicating the first path data, changing the position of the path in the XY direction, and then changing the orientation of the path by 180° from the orientation in the first path data. The same applies to the third path data.

According to a method for manufacturing a three-dimensional shaped object in Modification 2, in the path data duplication step of step S120, the orientation of the path represented by the second path data can be changed from the orientation of the path represented by the first path data. Therefore, the second shaped object M2 can be disposed on the stage 210 in an orientation rotated by a certain angle with respect to the first shaped object M1. Accordingly, compared to a case where the orientation of each shaped object cannot be changed, a distance between the shaped objects can be shortened and the shaped objects can be disposed on the stage 210, and thus more shaped objects can be shaped at once.

### 2-3. Modification 3

In the above embodiment, an aspect in which the plurality of shaped objects are shaped in the same size has been described, but the plurality of shaped objects may be shaped in different sizes as long as the shapes of the paths are the same. That is, in the path data duplication step of step S120, the sizes of the paths represented by the second path data and the third path data may be changeable from the size of the path represented by the first path data. The size of each shaped object is designated by the user as, for example, a magnification with respect to the size of the path represented by the first path data.

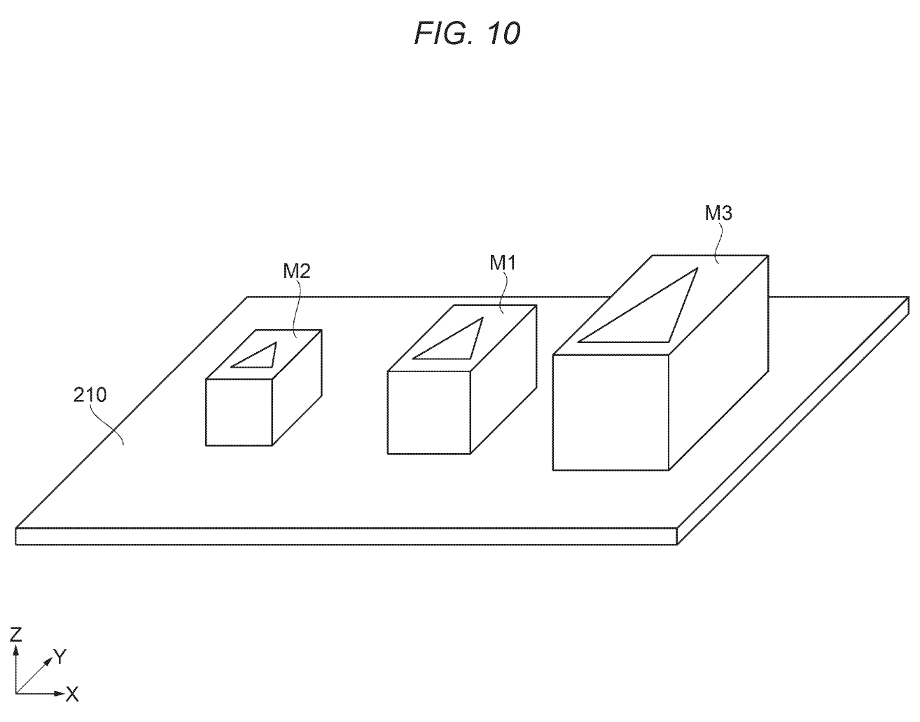

FIG. 10 is a diagram showing an example in which three shaped objects are shaped in different sizes. FIG. 10 shows the first shaped object M1, the second shaped object M2 obtained by reducing the first shaped object M1 by 0.75 times, and the third shaped object M3 obtained by enlarging the first shaped object M1 by 1.5 times. That is, the sizes of the paths of the second shaped object M2 and the third shaped object M3 are different from the size of the path in the first path data. In this case, in the path data duplication step of step S120, the information processing device 400 generates the second path data by duplicating the first path data, changing the position of the path in the XY direction, and then changing the size of the path from the size of the path in the first path data. The same applies to the third path data. Changing the size of the path means increasing or decreasing a length, a width, and a height of the path.

According to a method for manufacturing a three-dimensional shaped object in Modification 3, in the path data duplication step of step S120, the size of the path represented by the second path data can be changed from the size of the path represented by the first path data. That is, when the path represented by the first path data is used as a reference, the magnification of the path represented by the second path data can be changed. Accordingly, since the user can freely designate the size of the duplicated shaped object, for example, it is possible to perform shaping in consideration of material shrinkage during solidification of the shaped object while securing the shaping quality to some extent.

### 2-4. Modification 4

In the above embodiment, a shaping order of the first shaped object M1, the second shaped object M2, and the third shaped object M3 may be changeable for each layer ML. In this case, for example, in the N+1-th layer after the N-th layer is shaped in the order of the second shaped object M2, the first shaped object M1, and the third shaped object M3, the third shaped object M3, the first shaped object M1, and the second shaped object M2 can be shaped in this order contrary to the N-th layer, or the second shaped object M2, the first shaped object M1, and the third shaped object M3 can be shaped in this order similarly to the N-th layer. The order of shaping can be freely set by the user depending on the position on the stage 210 and the surrounding environment. The order of shaping set by the user is reflected in the shaping data in the shaping data generation step of step S130.

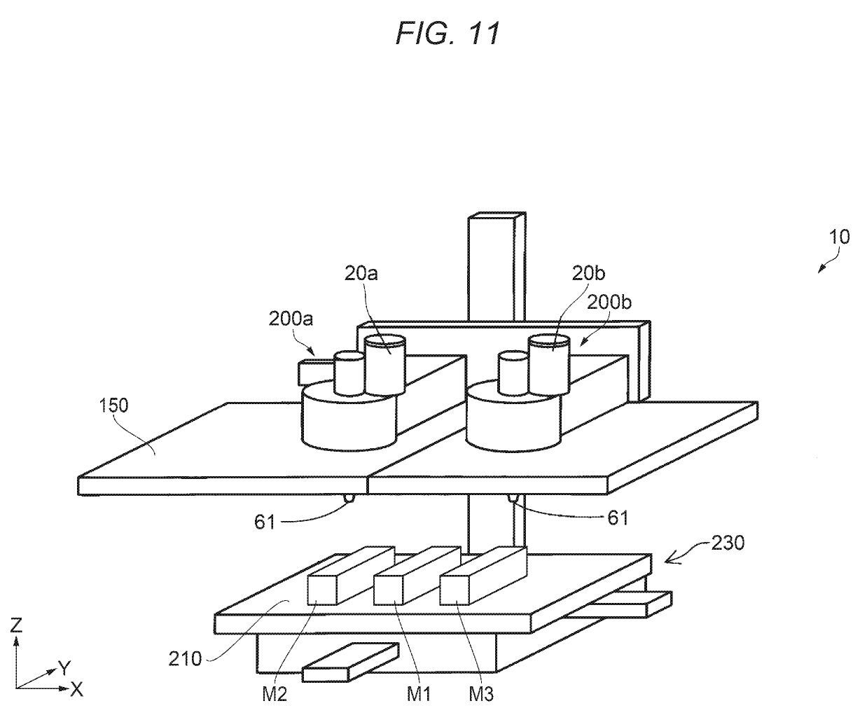

For example, as shown in FIG. 11, in a configuration in which a heater 150 is provided above the stage 210, a heating temperature as the surrounding environment may be different between a central part and a peripheral edge part of the heater 150. At this time, depending on how the shaped objects are disposed on the stage 210, the degree of shrinkage of the material may be different between the plurality of shaped objects. In such a case, the influence of the difference in the heating temperature can be limited by appropriately designating the order of shaping.

For example, when the temperature of the central part is higher than the temperature of the peripheral edge part of the heater 150, the second shaped object M2 and the third shaped object M3 shaped at an end portion of the stage 210 are less likely to be heated than the first shaped object M1, and thus warpage due to cooling of the shaped objects is likely to occur. Therefore, rather than shaping the second shaped object M2, the first shaped object M1, the third shaped object M3, the third shaped object M3, the first shaped object M1, and the second shaped object M2, … in this order, when shaping is performed in the order of the first shaped object M1, the second shaped object M2, the third shaped object M3, the first shaped object M1, the second shaped object M2, and the third shaped object M3, …, the time for the second shaped object M2 and the third shaped object M3 to be cooled can be shortened, and thus warpage can be reduced.

According to a method for manufacturing a three-dimensional shaped object in Modification 4, in the shaping data generation step of step S130, the order of shaping respective layers of the first shaped object M1, the second shaped object M2, and the third shaped object M3 can be changed. Therefore, the influence of the position of each shaped object on the stage 210 and the surrounding environment can be limited.

### 2-5. Other Modifications

The present disclosure includes a configuration that is substantially the same as the configuration described in the embodiment, such as a configuration having the same function, using the method, and providing the same result, or a configuration having the same object and providing the same advantages. The present disclosure further includes a configuration in which a non-essential portion of the configuration described in the embodiment is replaced with another portion. The present disclosure includes configurations that exert the same functions and advantages or configurations that can achieve the same objects as those of the configurations described in the embodiment. The present disclosure includes a configuration with the addition of a known technique to the configuration described in the embodiment.

The present disclosure is not limited to the embodiments described above, and can be implemented in various aspects without departing from the scope of the present disclosure. For example, the present disclosure can also be implemented in the following aspects. The technical features in the embodiment described above corresponding to the technical features in the aspects described below can be replaced with other technical features or combined with each other as appropriate in order to solve a part or all of the problems of the present disclosure, or to achieve a part or all of the advantages of the present disclosure. In addition, the technical features can be deleted as appropriate unless described as essential features in the present specification.

In the above embodiment, an aspect in which the first shaped object M1 is shaped based on the first path data which is the path data of the duplication source has been described, but the first shaped object M1 may not be shaped. That is, only the second shaped object M2 and the third shaped object M3 may be shaped based on the second path data and the third path data which are path data duplicated from the first path data. The user may be allowed to select a first mode in which the first shaped object M1 is shaped based on the first path data, which is the path data of the duplication source, and a second mode in which the first shaped object M1 is not shaped.

The embodiment and modifications described above are merely examples, and the present disclosure is not limited thereto. For example, the embodiment and modifications can be combined with each other as appropriate. That is, two or more items among the position in the XY direction, the position in the Z direction, the orientation, the size, and the shaping order of the plurality of shaped objects may be simultaneously changeable.

What is claimed is:

1. A method for manufacturing a three-dimensional shaped object for shaping a second shaped object, which is a duplicate of a first shaped object, on a stage by ejecting a shaping material from an ejecting unit toward the stage, the method comprising:
an acquisition step of acquiring first path data for shaping the first shaped object;
a duplication step of generating second path data for shaping the second shaped object, based on the first path data and a position at which the second shaped object is to be shaped on the stage; and
a shaping step of shaping the second shaped object based on the second path data.

2. The method for manufacturing a three-dimensional shaped object according to claim 1, wherein
in the shaping step, the first shaped object and the second shaped object are shaped side by side based on the first path data and the second path data.

3. The method for manufacturing a three-dimensional shaped object according to claim 2, wherein
a path represented by the second path data does not intersect a path represented by the first path data.

4. The method for manufacturing a three-dimensional shaped object according to claim 1, wherein
in the duplication step, a position of a path represented by the second path data in a direction intersecting the stage is changeable from a position of a path represented by the first path data in the direction intersecting the stage.

5. The method for manufacturing a three-dimensional shaped object according to claim 1, wherein
in the duplication step, an orientation of a path represented by the second path data is changeable from an orientation of a path represented by the first path data.

6. The method for manufacturing a three-dimensional shaped object according to claim 1, wherein
in the duplication step, a size of a path represented by the second path data is changeable from a size of a path represented by the first path data.

7. The method for manufacturing a three-dimensional shaped object according to claim 2, wherein
an order of shaping respective layers of the first shaped object and the second shaped object is changeable.
